(19) United States
(12) Patent Application Publication
(10) Pub. No.: US 2015/0124994 A1
(43) Pub. Date: May 7, 2015

(54) Wireless Speaker Apparatus for Multimedia Device

(71) Applicants: George F. Cheung, La Mirada, CA (US); Peter Lee, Huntington Beach, CA (US)

(72) Inventors: George F. Cheung, La Mirada, CA (US); Peter Lee, Huntington Beach, CA (US)

(21) Appl. No.: 14/535,108

(22) Filed: Nov. 6, 2014

Related U.S. Application Data
(60) Provisional application No. 61/900,672, filed on Nov. 6, 2013.

(51) Int. Cl. H04R 3/00

(52) U.S. Cl. CPC H04R 3/00; H04R 2420/07
USPC 381/77

(57) ABSTRACT

A wireless speaker apparatus includes a signal transmission module and a wireless speaker unit. The signal transmission module electrically connects to an audio output of the multimedia device, and is arranged to send out wireless signal corresponding to the audio output. The wireless speaker unit includes a speaker housing configured to stand on a flat surface, a signal receiver, a control circuitry, and a speaker. The signal receiver is arranged to receive wireless signal from the signal transmission module. The speaker electrically connects to the control circuitry, and is configured to deliver audible sound corresponding to the audio output of the multimedia device.

### CROSS REFERENCES TO RELATED APPLICATIONS

This is a non-provisional application which claims priority under 35 U.S.C. §119 to a provision application having an application Ser. No. 61/900,672 and a filing date of Nov. 6, 2013. The contents of the specification are incorporated herein by reference.

### BACKGROUND OF THE PRESENT INVENTION

1. Field of Invention

The present invention relates to a speaker apparatus, and more particularly to a wireless speaker apparatus which is adapted to wirelessly connect to a multimedia device for delivering audible sound thereof.

2. Description of Related Arts

A conventional wireless headphone, such as a wireless headphone for use with a multimedia device, usually comprises two loudspeakers and a headband connecting the two loudspeakers. The headband may be equipped with a signal receiver for receiving wireless signal from the multimedia device. The two loudspeakers are adapted for generating audible sound corresponding to the audio signal outputted by the multimedia device.

There are several disadvantages in association with the above mentioned conventional wireless headphone. First, the conventional wireless headphone is designed to wear on a user's head. There are many situations in which this mode of wearing is not suitable or desirable. For example, when the user is wearing eyeglasses, wearing an additional headphone on the user's head may cause slight displacement of the eyeglasses on the user's head. Even though there is no movement on the part of the eyeglasses, the user may nevertheless feel uncomfortable because the loudspeakers may partially cover the temples of the eyeglasses.

Second, when a user is wearing the wireless headphone, he may not lie down on a flat surface because doing so may interfere with the position of the headphone. Therefore, for example, the user may not utilize the headphone for listening to music while lying on bed. This disadvantage of conventional wireless headphone substantially limits the circumstances in which it can be comfortably utilized.

### SUMMARY OF THE PRESENT INVENTION

An objective of the present invention is to provide a wireless speaker apparatus for a multimedia device, wherein the wireless speaker apparatus may wirelessly receive audio signals from the multimedia device and deliver corresponding audible sound.

Another objective of the present invention is to provide a wireless speaker apparatus comprising a wireless speaker unit, wherein the wireless speaker unit does not require to be worn on a user's body before it can deliver audible sound to that user.

Another objective of the present invention is to provide a wireless speaker apparatus comprising a wireless speaker unit, which may securely stand on a flat surface so that a user may listen to the audible sound delivered by the multimedia device while he doing something else, such as doing housework.

In one aspect of the present invention, it provides a wireless speaker apparatus for at least one multimedia device having an audio output, comprising:

a signal transmission module electrically connecting to the audio output of the multimedia device, and is arranged to send out wireless signal corresponding to the audio output of the multimedia device; and

a wireless speaker unit, which comprises:

a speaker housing configured to stand on a flat surface;

a signal receiver mounted in the speaker housing and arranged to receive wireless signal from the signal transmission module;

a control circuitry electrically connecting to the signal receiver; and

a speaker providing in the speaker housing, and electrically connecting to the control circuitry, wherein the speaker is configured to deliver audible sound corresponding to the audio output of the multimedia device.

### BRIEF DESCRIPTION OF THE DRAWINGS

FIG. 1 is front perspective view of a wireless speaker apparatus according to a preferred embodiment of the present invention.

FIG. 2 is a schematic diagram of the wireless speaker apparatus according to the preferred embodiment of the present invention

FIG. 3 is an exploded perspective view of the wireless speaker apparatus according to the preferred embodiment of the present invention.

FIG. 4A is a block diagram illustrating the circuit design of a utility docking of the wireless speaker apparatus according to the preferred embodiment of the present invention.

FIG. 4B is a block diagram illustrating the circuit design of a wireless speaking unit of the wireless speaker apparatus according to the preferred embodiment of the present invention.

FIG. 5 is a circuit diagram of the utility docking of the wireless speaker apparatus according to the preferred embodiment of the present invention.

FIG. 6A to FIG. 6D are circuit diagrams of the wireless speaker unit of the wireless speaker apparatus according to the preferred embodiment of the present invention.

FIG. 7 is a schematic diagram of an operation of the wireless speaker unit according to the preferred embodiment of the present invention.

### DETAILED DESCRIPTION OF THE PREFERRED EMBODIMENT

The following detailed description of the preferred embodiment is the preferred mode of carrying out the invention. The description is not to be taken in any limiting sense. It is presented for the purpose of illustrating the general principles of the present invention. Each of the inventive features described below can be used independently of one another or in combination with other features.

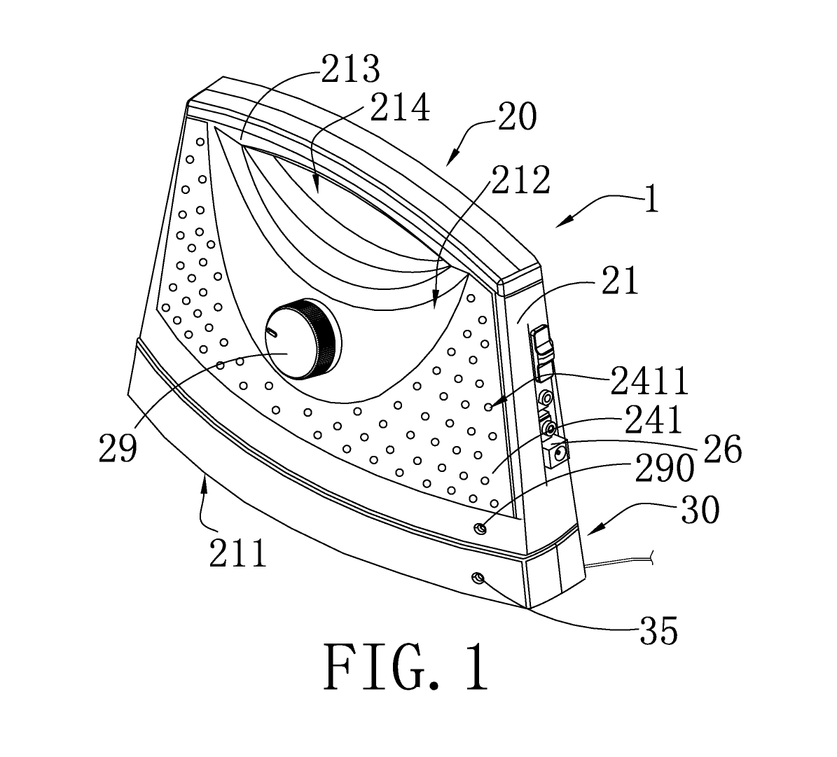

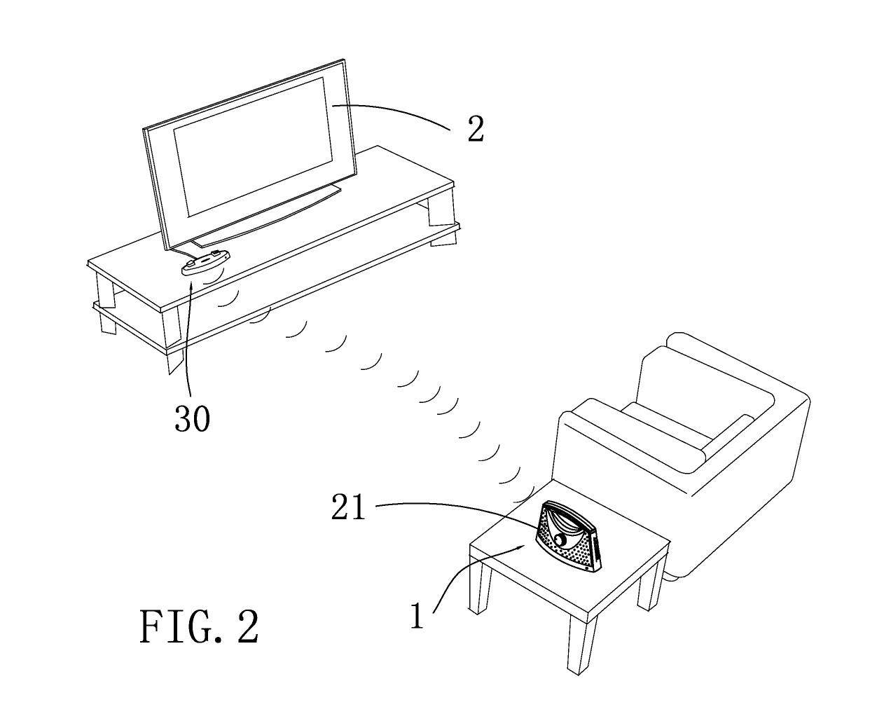

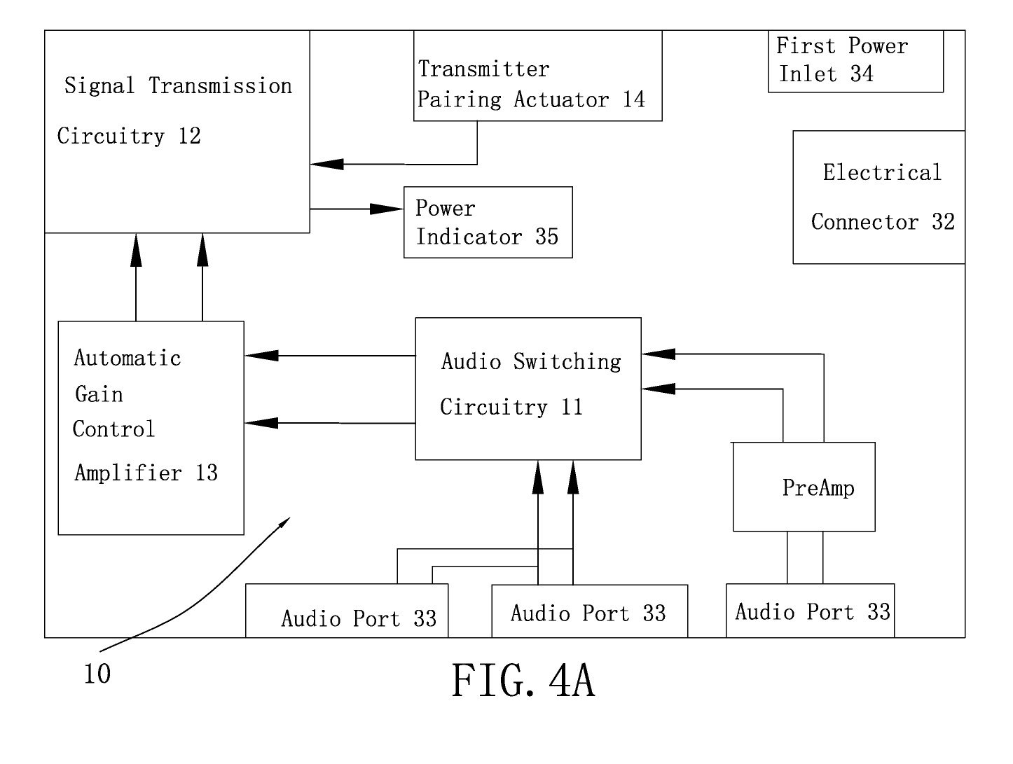

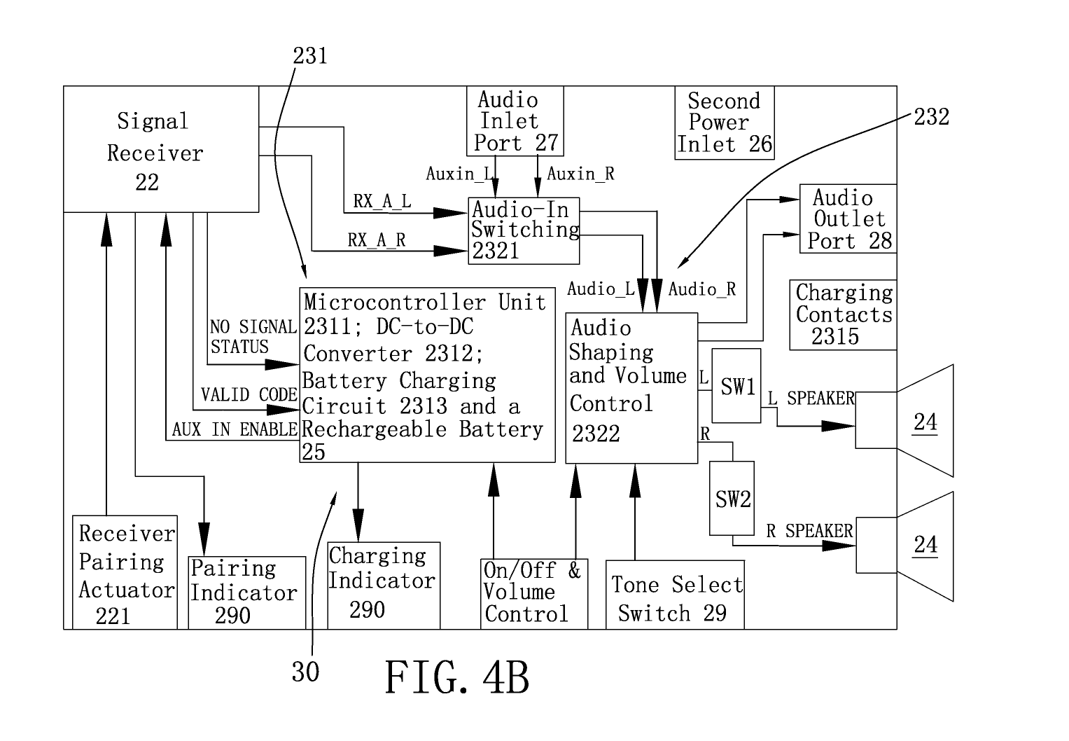

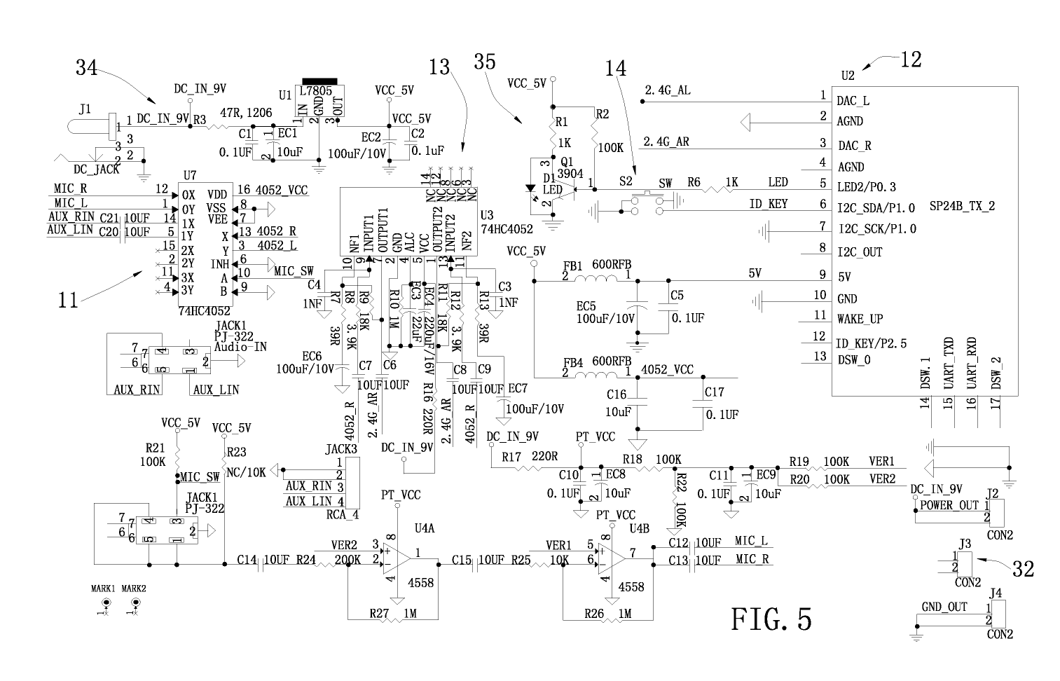

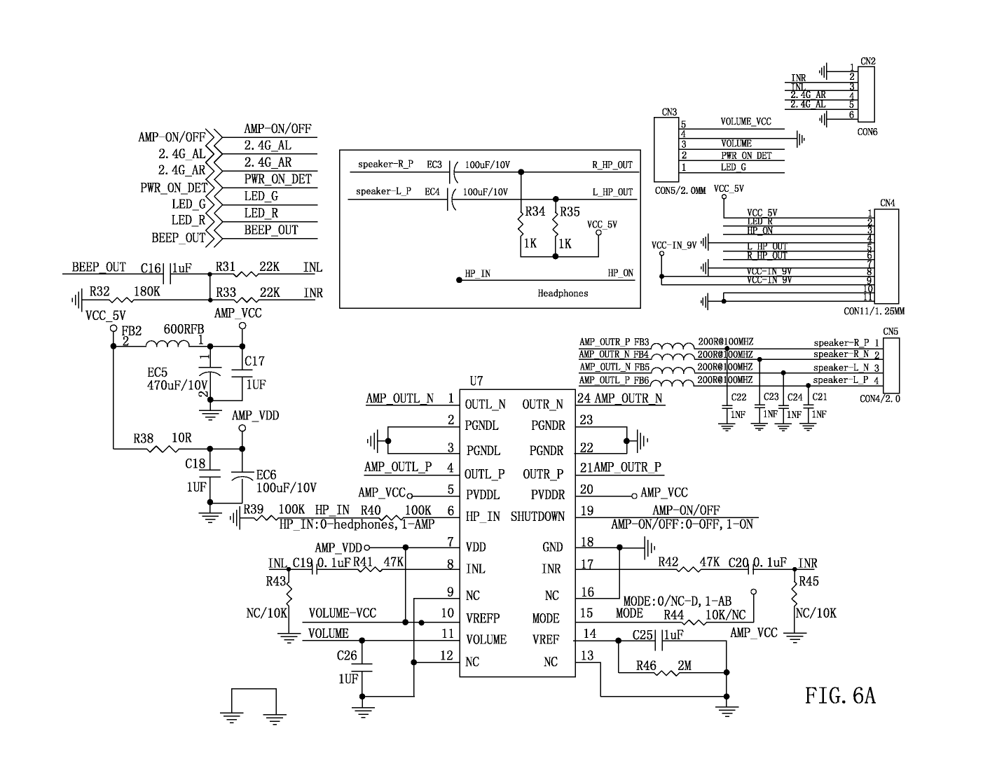

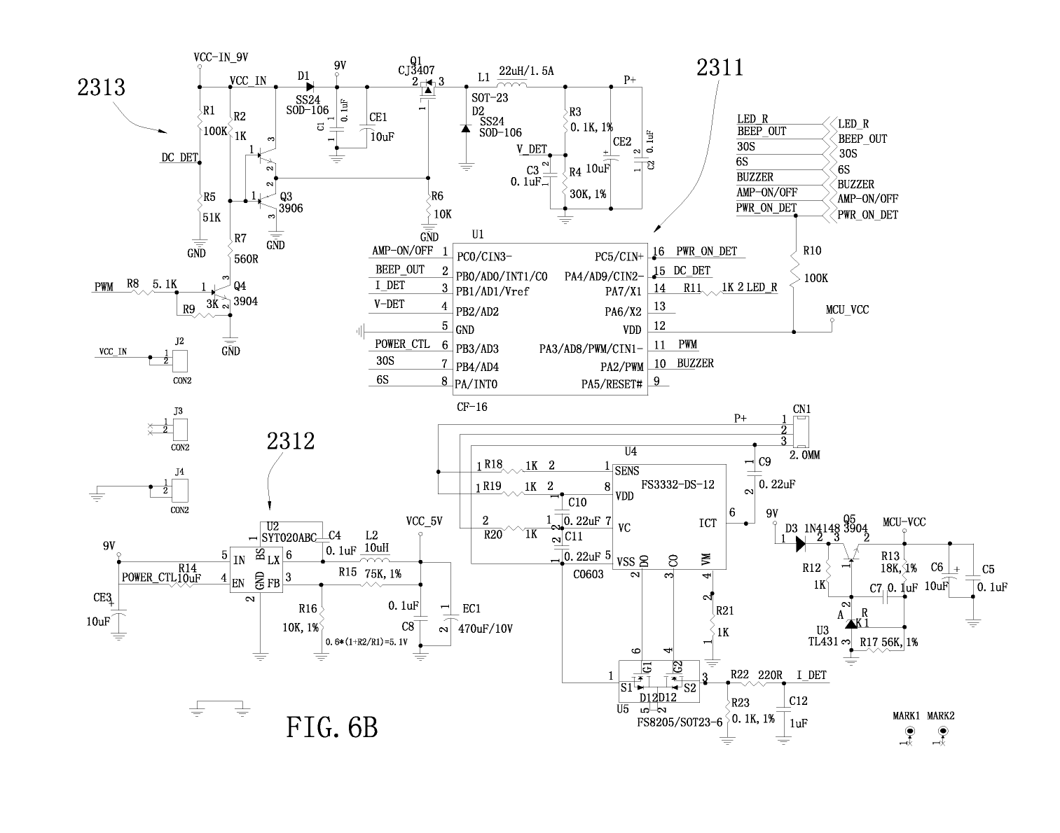

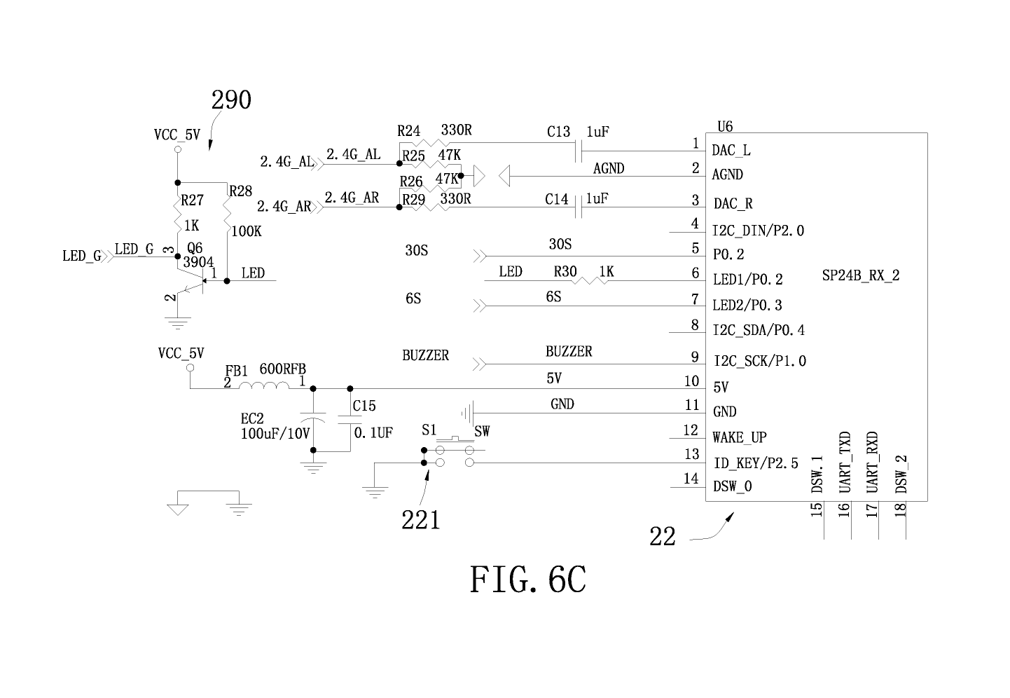

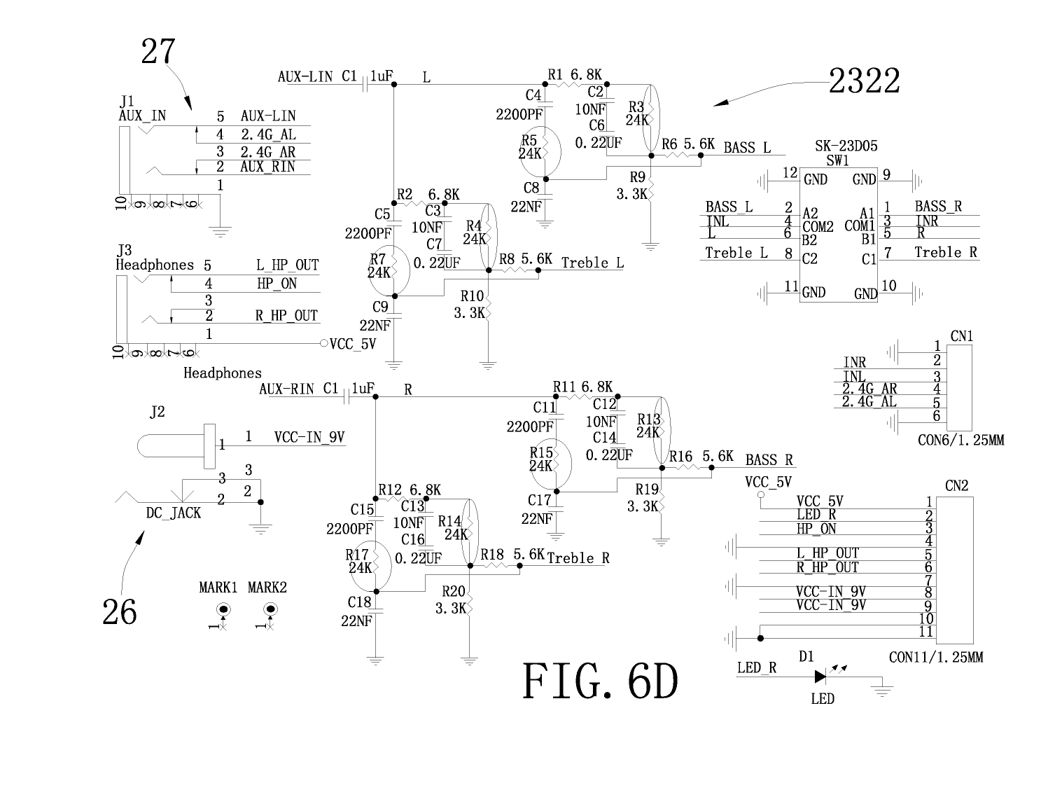

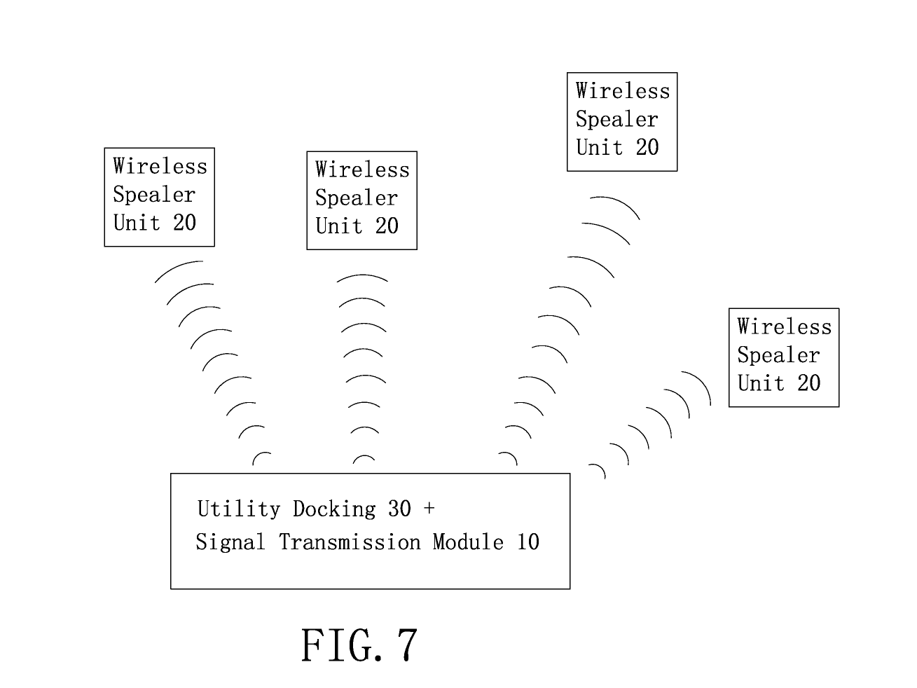

Referring to FIG. 1 to FIG. 3, FIG. 4A to FIG. 4B, and FIG. 5, FIG. 6A to FIG. 6D, and FIG. 7 of the drawings, a wireless speaker apparatus 1 according to a preferred embodiment of the present invention is illustrated. Broadly, the wireless speaker apparatus 1 comprises a signal transmission module 10 and a wireless speaker unit 20. The wireless speaker apparatus 1 is for at least one multimedia device 2 having an audio output. An example of such a multimedia device 2 is a television as shown in FIG. 2 of the drawings.

The signal transmission module 10 is electrically connected to the audio output of the multimedia device 2, and is arranged to send out wireless signals corresponding to the audio output of the multimedia device 2.

On the other hand, the wireless speaker unit 20 comprises a speaker housing 21 configured to stand on a flat surface, a signal receiver 22, a control circuitry 23 electrically connecting to the signal receiver 22, and at least one speaker 24.

The signal receiver 22 is received in the speaker housing 21 and is arranged to receive wireless signals transmitting from the signal transmission module 10. The speaker 24 is provided on the speaker housing 21, and is electrically connected to the control circuitry 23. Furthermore, the speaker 24 is configured to deliver audible sound corresponding to the audio output of the multimedia device 2. Thus, the wireless speaker apparatus 1 is arranged to deliver audible sound outputted by the multimedia device 2 at a distance therefrom.

According to the preferred embodiment of the present invention, the wireless speaker apparatus 1 further comprises a utility docking 30, wherein the signal transmission module 10 is received in the utility docking 30. The signal transmission module 10 is received in the utility docking 30 and is electrically connected to an audio output of the multimedia device 2, preferably through an audio cable. Alternatively, the signal transmission module 10 may also connect to the audio output of the multimedia device 2 through wireless technology (i.e. in a wireless manner) such as Bluetooth technology.

The utility docking 30 comprises a docking housing 31, an electrical connector 32 provided on the docking housing 31 to electrically connect to the wireless speaker unit 20, and at least one audio port 33 also provided on the docking housing 31 for allowing the multimedia device 2 to electrically connect to the signal transmission module 10 through the audio port 33. The electrical connector 32 is a charging contact which is adapted to output DC power to the wireless speaker unit 20.

Furthermore, the utility docking 30 further comprises a first power inlet 34 for electrically connecting to an external power source, such as an external AC power source, through an electrical adapter. Thus, the power adapter may convert the external AC power into a DC output which is fed into the power input 34 of the utility docking 30. The power may also be used to recharge the wireless speaker unit 20 and maintain operation of the utility docking 30.

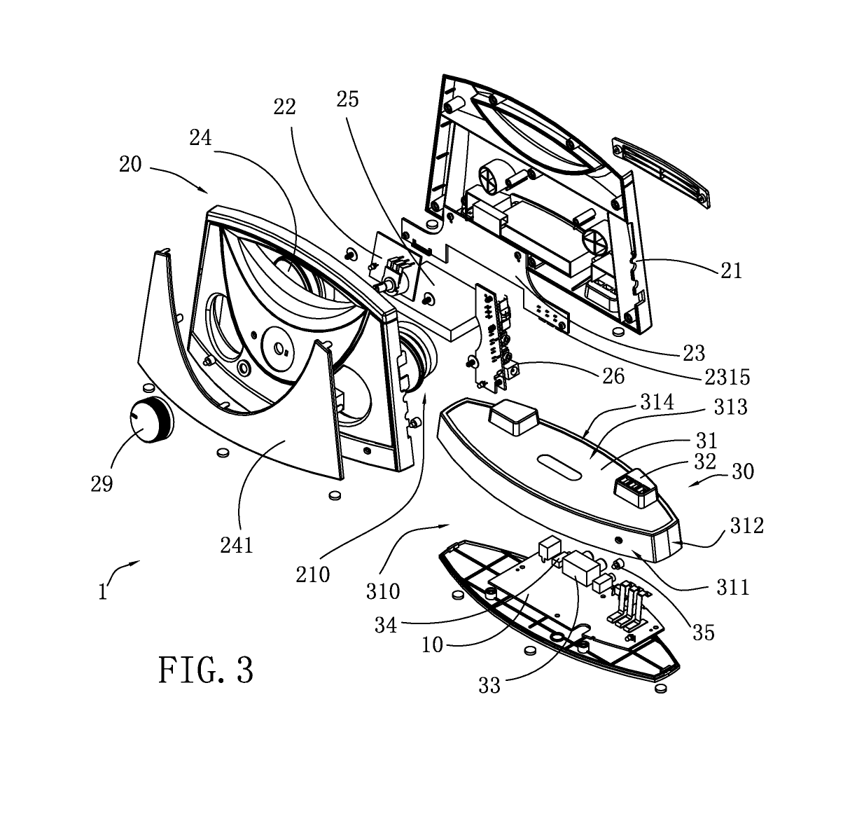

The docking housing 31 defines a housing cavity 310 therewithin and may have an elongated structure having two opposed longitudinal side edges 311 and two opposed transverse side edges 312. Moreover, the docking housing 31 further has a top supporting platform 313 for detachably supporting the wireless speaker unit 20. As shown in FIG. 3 of the drawings, the top supporting platform 313 may be surrounded by a top rim 314. The top supporting platform 313 is slightly indented with respect to the top rim 314. This indention allows the wireless speaker unit 20 to be disposed on the top supporting platform 313 in a secure manner, because the top rim 314 may be utilized for restricting a collateral movement between the wireless speaker unit 20 and the docking housing 31.

The electrical connector 32 may upwardly extend from the supporting platform 313 to connect to the wireless speaker unit 20. The audio port 33 and the first power inlet 34 may also upwardly extend from the supporting platform 313 for connecting to the audio output and the adapter respectively. In this preferred embodiment, the utility docking 30 comprises three audio ports 33 in which one of them is a 3.5 mm jack input, the second one of them is a RCA connector, and the third one is a microphone input. These three types of audio ports 33 ensure maximum compatibility with different multimedia devices 2 and to receive audio signal from an external microphone module. The microphone input is set to have a higher priority over the jack input and the RCA connector.

The signal transmission module 10 is electrically connected to the electrical connector 32, at least one of the audio ports 33 and the first power inlet 34. Specifically, the signal transmission module 10 is responsible for processing of the audio signals from the multimedia device 2. As shown in FIG. 4A of the drawings, the signal transmission module 10 comprises an audio switching circuitry 11 electrically connecting to the audio port 33, and a signal transmission circuitry 12 electrically connecting to the audio switching circuitry 11 through an Automatic Gain Control (AGC) amplifier 13.

The audio switching circuitry 11 determines which one of the audio ports 33 is connected. In this preferred embodiment, once the microphone input is connected, the other two audio ports 33 will be deactivated.

In this preferred embodiment, the signal transmission module 10 is received in the utility docking 30. The signal transmission circuitry 12 comprises a 2.4 GHz transmitter module which is arranged to receive audio signal from the AGC amplifier 13, and modulate a 2.4 GHz RF carrier for wireless transmission to the wireless speaker unit 20. The signal transmission circuitry 12 has an etched antenna for radiating the 2.4 GHz RF carrier into free space. One having ordinary skill in the art will also appreciate that other frequencies may also be used.

The signal transmission circuitry 12 is arranged to perform pairing between the signal transmission module 10 and the wireless speaker unit 20. The process ensures that only the RF signal from the signal transmission circuitry 12 can be received by the wireless speaker unit 20. This avoids interferences from adjacent un-paired signal transmitters. Thus, the signal transmission module 10 further comprises a transmitter pairing actuator 14 providing on the utility docking 30 for selectively actuating a pairing process between the signal transmission module 10 and the wireless speaker unit 20.

The utility docking 30 further comprises a power indicator 35 for indicating a power status of the utility docking 30 or a pairing status of the signal transmission module 10.

On the other hand, the AGC amplifier 13 is arranged to amplify the audio signal from the audio switching circuitry 11 or to reduce the gain if the audio signal is already very strong so as to minimize signal distortion.

The wireless speaker unit 20 is normally placed at a distance from the utility docking 30 so that a user of the present invention may hear the audio sound outputted by the multimedia device 2. However, when the wireless speaker unit 20 is not in use, the user may put it on the utility docking 30 to recharge the wireless speaker unit 20 for future use.

As shown in FIG. 3 of the drawings, the speaker housing 21 of the wireless speaker unit 20 has a receiving cavity 210 for accommodating the signal receiver 22, the control circuitry 23, the speaker 24 and the rechargeable battery 25. The speaker housing 21 has a flat bottom surface 211 adapted for resting on a flat surface, and a main housing body 212 upwardly extending from the bottom surface 211. Thus, the speaker housing 21 may stand on a flat surface so that a user needs not to wear the wireless speaker unit 20 on his or her body. A feature of the present invention is to provide a wireless speaker unit 20 which may individually stand on a flat surface, such as on a tabletop, so that the user may leave the wireless speaker unit 20 on a desirable location while listening to the audible sound delivered by the multimedia device 2. In this scenario, the multimedia device 2 may or may not produce sound through its own speaker.

As shown in FIG. 1 and FIG. 3 of the drawings, the speaker housing 21 may have a substantially rectangular cross section in which a longitudinal length of the speaker housing 21 is substantially greater than a transverse width of the speaker housing 21. It is worth mentioning that the speaker housing 21 may have any other cross section as long as it can stand on a flat surface and is corresponding to that of the utility docking 30.

The speaker 24 may orient toward a front side of the main housing body 212 of the speaker housing 21. A grid member 241 may be attached on the front side of the main housing body 212 to cover the speaker 24. As such, the audible sound generated by the speaker 24 may be delivered to an exterior of the speaker housing 21 through the grid member 241. Thus, the grid member 241 has a plurality of openings 2411 forming thereon for allowing passage of sound waves from the speaker 24.

As shown in FIG. 1 of the drawings, the main housing body 212 may be configured to form a handle 213 on an upper portion thereof so that a user may conveniently carry the wireless speaker unit 20 by grabbing on the handle 213. In this preferred embodiment, a through handle slot 214 is formed on the upper portion of the wireless speaker unit 20 so that a user may penetrate his or her hand through the handle 213 and grab on the handle 213 for carrying the wireless speaker unit 20.

The wireless speaker unit 20 further comprises a second power inlet 26 which is provided on the speaker housing 21 and is electrically connected to the control circuitry 23, wherein external power (such as a DC voltage) can be supplied to the control circuitry 23 for operation of the wireless speaker unit 20. This allows the user of the present invention to keep the wireless speaker unit 20 anywhere without returning to the utility docking 30 for regular charging.

The signal receiver 22 is electrically connected to the control circuitry 23 and is arranged to receive wireless signal from the signal transmission module 10. The signal receiver 22 may preferably be embodied as a 2.4 GHz radio frequency receiver module mounted in the speaker housing 21 of the wireless speaker unit 20. It is worth mentioning that the signal receiver 22 can also be embodied as other wireless receiving equipment, such as a Bluetooth receiver.

In this preferred embodiment, the signal receiver 22 is arranged to receive RF signal from the signal transmission module 10 and demodulate the RF signal. The demodulated signal is the audio input information received by the signal transmission module 10 from the multimedia device 2.

The signal receiver 22 is arranged to perform pairing with the signal transmission module 10 so that the signal receiver will only receive the RF signal sending from the paired signal transmission module 10. To complete a pairing process with a predetermined signal transmission module 10, the signal transmission module 10 must be in pairing mode. Thus, the signal receiver 22 comprises a receiver pairing actuator 221 providing on the speaker housing 21 for selectively actuating a pairing process with the signal transmission module 10.

On the other hand, the control circuitry 23 comprises a battery charging module 231 and an audio processing module 232. As shown in FIG. 4B of the drawings, the battery charging module 231 comprises a microcontroller unit 2311 electrically connecting to the signal receiver 22, a DC-to-DC converter 2312 electrically connected to the microcontroller unit 231, a battery charging circuitry 2313 electrically connected to the microcontroller unit 231 and the DC-to-DC converter 232. The battery charging module 231 is electrically connected to the rechargeable battery 25 for charging thereof when it is connected to an external power source.

The battery charging module 231 further comprises a plurality of charging contacts 2315 providing on the wireless speaker unit 20 and are electrically connected to the control circuitry 23. The charging contacts 2315 are positioned to align with the electrical connector 32 of the utility docking 30 when the wireless speaker unit 20 is suitably placed on the utility docking 30. This allows the rechargeable battery 25 to be recharged through the use of the utility docking 30.

On the other hand, the audio processing module 232 comprises an audio switching circuitry 2321 electrically connected to the signal receiver 22 for selecting audio input signals to be processed, and an audio shaping and volume control circuitry 2322 electrically connected to the audio switching circuitry 2321 and the speaker 24, wherein the selected audio signals coming from the audio switching circuitry 2321 are transmitted to the audio shaping and volume control circuitry 2322 for further processing, while processed audio signals are transmitted to the speaker 24 which is arranged to deliver corresponding audible sound. The audio shaping and volume control circuitry 2322 may also be used to control the volume of audible sound as delivered by the speaker 24.

The wireless speaker unit 20 may also support wired connection for receiving audio signals. Thus, the wireless speaker unit 20 further comprises an audio inlet port 27 and an audio outlet port 28 providing on the speaker housing 21. The audio inlet port 27 is electrically connected to the audio switching circuitry 2321, while the audio outlet port 28 is electrically connected to the audio shaping and volume control circuitry 2322. When the audio inlet port 27 receives an audio signal, the signal receiver 22 will be deactivated. In this scenario, only the audio signal coming from the audio inlet port 27 will be selected by the audio switching circuitry 2321 and further processed and delivered by the speaker 24. In this preferred embodiment, the audio inlet port 27 may comprise an input jack for the multimedia device 2, and a microphone jack for connecting to an external microphone. The audio outlet port 28 will allows the audio signal to be outputted to a headphone.

In addition, a plurality of control switches 29 may be provided on the speaker housing 21 for controlling an operation of the present invention. For example, a volume control knob 29 may be provided on a front side of the speaker housing 21 for allowing a user to adjust the volume of the speaker 24 as controlled by the audio shaping and volume control circuitry 2322. Moreover, one of the control switches 29 may be embodied as a tone select switch for allowing adjustment of frequency shaping setting. In this scenario, this control switch 29 is electrically connected to the audio shaping and volume control circuitry 2322.

The wireless speaker unit 20 may also comprise a plurality of indicators 290 providing on the speaker housing 21 for indicating an operation status of the wireless speaker unit 20. These indicators 290 may be embodied as a recharging indicator providing on the speaker housing 21 for indicating a charging status of the rechargeable battery 25. Another indicator 290 may be embodied as a pairing indicator for indicating a pairing status of the signal receiver 22. Note that a single indicator 290 may also be used for indicating multiple statuses.

The operation of the present invention is as follows: in this preferred embodiment, the signal transmission module 10 is mounted in the utility docking 30, which is electrically connected to the audio output of the multimedia device 2. When the multimedia device 2 is operating, audio signals outputted from the multimedia device 2 will be transmitted to the signal transmission module 10. The signal transmission module 10 will then process the audio signals and wirelessly transmit the audio signals to the wireless speaker unit 20 through the signal transmission circuitry 12.

When a recognized signal is received from the signal receiver 22, a corresponding signal is sent to the microcontroller unit 2311 indicating a valid RF signal is being received. This enables other components of the wireless speaker unit 20 to start working. If no RF signal is detected, a corresponding signal is also sent to the microcontroller unit 2311 for disabling other components of the wireless speaker unit 20.

The wireless speaker unit 20 may be placed at a distance from the utility docking 30 so that and near the reach of the user. The signal receiver 22 is arranged to receive the wireless audio signal which is transmitted to the audio switching circuitry 2321. As explained above, the processed signal will then be transmitted to the audio shaping and volume control circuitry 2322 and the speaker 24. The speaker 24 is arranged to deliver corresponding audio sound which is equivalent to the audible sound delivered by the multimedia device 2.

When the wireless speaker unit 20 is not in use, the user may place it on the utility docking 30 for charging of the rechargeable battery 25. Alternatively, the user does not necessarily put the wireless speaker unit 20 back to the utility docking 30 while it is not in use. The user may recharge the wireless speaker unit 20 by connecting it to an external power source, preferably through an adapter. The user will then recharge the rechargeable battery 25 by connecting the wireless speaker unit 20 to the external power source through the second power inlet 26. The block modules shown in FIG. 4A and FIG. 4B of the drawings are shown in details in FIG. 5, and FIG. 6A to FIG. 6D of the drawings.

More specifically, referring to FIG. 4A and FIG. 5 of the drawings, the signal transmission circuitry 12 comprises circuit module U2 (SP24B-TX-2), a highly integrated 2.4 GHz digital transmitter integrated circuit, and the associated power supply filters FB1, FB2, ECS, C16, C17, and C5. The transmitter pairing actuator 14 comprises element S2 as shown in FIG. 5. The power indicator 35 consists of elements D1, Q1, R1 and R2. The first power inlet 34 comprises elements J1 DC Jack, U1 L7805 voltage regulator and its associated filter capacitors. The electrical connector 32 comprises elements J2, J3, and J4 which are electrical contacts for charging the wireless speaker unit 20. The audio switching circuitry 11 comprises integrated circuit U7 which selects either microphone input signal or auxiliary audio input for listening. The AGC amplifier 13 comprises integrated circuit U3 which provides 40 DB of dynamic range, wherein the associated capacitors and resistors determines AGC attack time and decay time characteristics.

On the other hand, referring to FIG. 4B and FIG. 6A to FIG. 6D of the drawings, The signal receiver 22 (as shown in FIG. 6C) comprises circuit module U6 (SP24B-RX-2) which is a highly integrated 2.4 GHz digital receiver integrated circuit, wherein FB1, EC2, and C15 are its power supply filters. The indicator 290 comprises Q6, LED-G, R27 and R28. Moreover, the receiver pairing actuator 221 comprises S1-SW which is a pairing actuator switch. Note also that the charging indicator 290 is also controlled by microcontroller U1 as shown in FIG. 6B of the drawings. Pin 14 of microcontroller U1 drives the charging indicator 290 to operate.

As shown in FIG. 6B of the drawings, the microcontroller Unit 2311 comprises microcontroller U1 which is an 8-bit microcontroller that controls all housing keeping functions such as battery charging (by using Pulse Width Modulation technique), pairing and timing control, and remembering device pairing addresses. The battery charging circuitry 2313 comprises microcontroller U1 and associated transistors Q1, Q2, Q3, and Q4. Collectively, they switch the input power to charge the battery using a pulse width modulation format as determined by U1. Both charging voltage and current are monitored to ensure the proper battery charging is maintained.

The DC-To-DC Converter 2312 comprises two converter circuits in which the input voltage, 9 volt, is converted to 5 VDC and 3.3 VDC by the two different converter circuits respectively. Integrated circuit U2 is a switching regulator and produces a 5 VDC output for the 2.4 GHz digital receiver circuit block operation.

The rechargeable battery 25 is preferably a built-in Li-ion battery packaged together with battery protection devices integrated circuits U4 and U5. During extreme low battery voltage, integrated circuit U5 automatically disconnects the rechargeable battery 25 from its load in order to protect it from 100% discharging.

As shown in FIG. 6D of the drawings, the audio inlet port 27 can be represented by Jack J1 which accepts input from any external audio device. When a 3.5 mm plug is engaged into this jack, any internal signal from the signal receiver 22 will be disconnected. Only the external signal will be routed to the audio shaping and volume control circuitry 2322 for further processing.

The audio shaping and volume control circuitry 2322 is indicated in FIG. 6D of the drawings. Left-channel bass-frequency shaping is accomplished by resistors R1, R3, R5, R6, R9 and capacitors C2, C4, C6, C8, while left-channel treble-frequency shaping is accomplished by resistors R2, R7, R8, R10 and capacitors C3, C5, C7, C9. On the other hand, the right-channel bass-frequency shaping is accomplished by resistors R11, R13, R15, R16, R19 and capacitors C11, C12, C14, C17, while right-channel treble-frequency shaping is accomplished by resistors R12, R14, R17, R18, R20 and capacitors C13, C15, C16, C18.

One of the control switches 29 may select either bass, treble or normal output for subsequent processing by the stereo amplifier U7. This is a 5 watt per channel Class-D power amplifier. Its outputs are filtered by FB3, FB4, FB5, FB6 and C21, C22, C23, C24. These filters removed high frequency components and pass audio signals. These components are shown in FIG. 6A of the drawings.

U7 output volume is controlled by a DC voltage on its pin 11. This DC voltage is determined by one of the control switches 29 located on the front of the speaker housing 21. This control switch 29 also turns the unit on and off by applying a control voltage to pin 19 of U7.

The second power inlet 26 is represented by jack J2 in FIG. 6D and is arranged to accept an external 9 VDC power adapter input for operation. This allows the wireless speaker unit 20 to operate alone without ever returning to the utility docking 30 for charging.

As shown in FIG. 7 of the drawings, a single utility docking 30 and a single signal transmission module 10 may be used to transmit wireless signals to a plurality of wireless speaker units 20. In this scenario, the present invention may be used for facilitating extensive transmission of audible sound from a single multimedia device 2. For example, the present invention may be used in a senior house in which each member may have one wireless speaker unit 20 which is wirelessly connected to a single or central signal transmission module 10 so that each member of the senior house may be able to listen to the same audible sound coming from a signal multimedia device 2, such as a television. When some members want to stop listening to the audible sound, they may just switch off the corresponding wireless speaker units 20 and go to do something else, such as going to bed. Now, the key point here is that for those who wish to continue listening to the audible sound, they will not be interrupted by those who want to stop. The present invention provides such a flexibility in this multiple-user situation. Moreover, for those who wish to continue listening to the audible sound, they do not need to wear headphones.

The present invention, while illustrated and described in terms of a preferred embodiment and several alternatives, is not limited to the particular description contained in this specification. Additional alternative or equivalent components could also be used to practice the present invention.

What is claimed is:

1. A wireless speaker apparatus for at least one multimedia device having an audio output, comprising:
a signal transmission module electrically connecting to said audio output of said multimedia device, and is arranged to send out wireless signal corresponding to said audio output of said multimedia device; and
a wireless speaker unit, which comprises:
a speaker housing configured to stand on a flat surface;
a signal receiver mounted in the speaker housing and arranged to receive wireless signal from said signal transmission module;
a control circuitry electrically connecting to said signal receiver; and
a speaker providing in said speaker housing, and electrically connecting to said control circuitry, wherein said speaker is configured to deliver audible sound corresponding to said audio output of said multimedia device.

2. The wireless speaker apparatus, as recited in claim 1, further comprising a utility docking, wherein said signal transmission module is received in said utility docking

3. The wireless speaker apparatus, as recited in claim 2, wherein said utility docking comprises a docking housing, and an audio port providing on said docking housing for allowing said multimedia device to electrically connect to said signal transmission module through said audio port.

4. The wireless speaker apparatus, as recited in claim 3, wherein said utility docking further comprises an electrical connector providing on said docking housing to electrically connect to said wireless speaker unit, and a first power inlet adapted for electrically connecting to an external power source.

5. The wireless speaker apparatus, as recited in claim 4, wherein said docking housing defines a housing cavity and a top supporting platform forming on a top side of said docking housing, wherein said supporting platform is shaped and sized to fittedly and securely support said wireless speaker unit.

6. The wireless speaker apparatus, as recited in claim 5, wherein said docking housing further has a top rim upwardly extending along a peripheral side edge of said top supporting platform, so that said top supporting platform is slightly indented with respect to said top rim.

7. The wireless speaker apparatus, as recited in claim 3, wherein said signal transmission module comprises an audio switching circuitry electrically connecting to said audio port, and a signal transmission circuitry electrically connecting to said audio switching circuitry.

8. The wireless speaker apparatus, as recited in claim 7, wherein said signal transmission module comprises an audio switching circuitry electrically connecting to said audio port, and a signal transmission circuitry electrically connecting to said audio switching circuitry

9. The wireless speaker apparatus, as recited in claim 1, wherein said speaker housing has a receiving cavity, a flat bottom surface configured to rest on a flat surface, and a main housing body upwardly extending from said bottom surface.

10. The wireless speaker apparatus, as recited in claim 8, wherein said speaker housing has a receiving cavity, a flat bottom surface configured to rest on a flat surface, and a main housing body upwardly extending from said bottom surface.

11. The wireless speaker apparatus, as recited in claim 1, wherein said speaker housing has a substantially rectangular cross section in which a longitudinal length of said speaker housing is substantially greater than a transverse width of said speaker housing.

12. The wireless speaker apparatus, as recited in claim 10, wherein said speaker housing has a substantially rectangular cross section in which a longitudinal length of said speaker housing is substantially greater than a transverse width of said speaker housing.

13. The wireless speaker apparatus, as recited in claim 1, wherein said speaker housing is configured to form a handle on an upper portion thereof in such a manner that a through handle slot is formed on said upper portion of said speaker housing.

14. The wireless speaker apparatus, as recited in claim 12, wherein said speaker housing is configured to form a handle on an upper portion thereof in such a manner that a through handle slot is formed on said upper portion of said speaker housing.

15. The wireless speaker apparatus, as recited in claim 1, wherein said wireless speaker unit further comprises a second power inlet providing on said speaker housing and electrically connecting to said control circuitry.

16. The wireless speaker apparatus, as recited in claim 14, wherein said wireless speaker unit further comprises a second power inlet providing on said speaker housing and electrically connecting to said control circuitry.

17. The wireless speaker apparatus, as recited in claim 1, wherein said control circuitry comprises a battery charging module and an audio processing module, wherein said battery charging module comprises a microcontroller unit electrically connecting to said signal receiver, a DC-to-DC converter electrically connecting to said microcontroller unit, a battery charging circuitry electrically connecting to said microcontroller unit and said DC-to-DC converter, wherein said battery charging module is electrically connected to said rechargeable battery for charging thereof.

18. The wireless speaker apparatus, as recited in claim 16, wherein said control circuitry comprises a battery charging module and an audio processing module, wherein said battery charging module comprises a microcontroller unit electrically connecting to said signal receiver, a DC-to-DC converter electrically connecting to said microcontroller unit, a battery charging circuitry electrically connecting to said microcontroller unit and said DC-to-DC converter, wherein said battery charging module is electrically connected to said rechargeable battery for charging thereof.

19. The wireless speaker apparatus, as recited in claim 17, wherein said audio processing module comprises an audio switching circuitry electrically connecting to said signal receiver, and an audio shaping and volume control circuitry electrically connecting to said audio switching circuitry and said speaker.

20. The wireless speaker apparatus, as recited in claim 18, wherein said audio processing module comprises an audio switching circuitry electrically connecting to said signal receiver, and an audio shaping and volume control circuitry electrically connecting to said audio switching circuitry and said speaker.
